(19) United States
(12) Patent Application Publication
(10) Pub. No.: US 2015/0127258 A1
(43) Pub. Date: May 7, 2015

(54) METHOD AND SYSTEM FOR PROVIDING REAL-TIME ASSISTANCE TO A TRAVELER

(71) Applicant: SOUNDHOUND, INC., SANTA CLARA, CA (US)

(72) Inventors: BERNARD MONT-REYNAUD, SUNNYVALE, CA (US); KEYVAN MOHAJER, LOS GATOS, CA (US); LARRY MARCUS, HILLSBOROUGH, CA (US)

(73) Assignee: SOUNDHOUND, INC., SANTA CLARA, CA (US)

(21) Appl. No.: 14/073,973

(22) Filed: Nov. 7, 2013

(51) Int. Cl. G01C 21/36

(52) U.S. Cl. CPC G01C 21/3679; G01C 21/36
USPC 701/539; 701/538

(57) ABSTRACT

A method and system for assisting a traveler. The method initiates a travel segment and interfaces with providers of data regarding geolocation, points of interest, or traffic. During execution of the method, the system monitors geolocation data. The system can predict a route of travel, basing that prediction on past geolocation data or directions from a geolocation provider. Also during execution of the method, the system can identify data of interest to a user, based on input initiated by the user. Further, the system can solicit input from the traveler, or it can perform tasks based on predefined criteria, such as locating and identifying points of interest between two geographic locations. During operation, system can provide information to the traveler relating to data of interest. The system includes a client unit and a server unit, the client unit being mounted in an automotive vehicle or in a communications device.

### TECHNICAL FIELD

Broadly, the presently disclosed embodiments relate to providing assistance to a traveler, and more particularly to providing real-time assistance relating to locations of interest to the traveler.

### BACKGROUND

Travelers today can take advantage of a variety of electronic assistance. Only a short time ago, periodic traffic reports on the radio were about the limit of information that one could receive on the road. Nowadays, GPS devices are available as stand-alone units, but more commonly, GPS technology is incorporated into automobiles, smartphones, tablet computers, and so on. Such devices can provide routing information, as well as all identification of points of interest, such as hotels, restaurants, and the like. In addition to providing directions to a given destination, some devices can provide an estimated time of arrival, and the device can provide updated information as the traveler progresses on a route.

Nonetheless, virtual travel assistants have only scratched the surface of their potential. While a user is progressing on a travel segment, her assistant may, for example, locate nearby restaurants that meet certain criteria that she defines. In current systems, the information returned after a restaurant search query will list all suitable restaurants within a given radius. Yet, if the traveler is moving at 70 mph on an interstate, much of the returned information will be useless, because many of the suggested locations would require the traveler to backtrack—an unlikely possibility. More helpful would be a system that can predict the traveler's future location, and make suggestions accordingly. It would be even more useful for the traveler to tell the assistant that she wishes to stop for lunch in about 30 minutes, and ask for restaurant suggestions in that time frame, with the understanding that suggested locations will be on or near the traveler's route. Answering such a query would require not only a knowledge of the traveler's current position, but also the ability to predict where the traveler will be in about 30 minutes. This task, and similar ones that also require the integration of external sources of information with the prediction of future locations, are not yet available in the art.

Thus, there remains considerable need for devices that can address information needs based on the requirements of the user, rather than offering limited capabilities of a single technology.

### SUMMARY

An aspect of the present disclosure is a method for assisting a traveler. The method commences by initiating a travel segment and interfacing with one or more providers of data regarding geolocation, points of interest, or traffic. During execution of the method, the system monitors geolocation data. The system can predict a route of travel, basing that prediction on past geolocation data or directions from geolocation provider. Also during execution of the method, the system can identify data of interest to a user, based on input initiated by the user. Further, the system can solicit input from the traveler, or it can perform tasks based on predefined criteria. During operation, system can provide information to the traveler relating to data of interest.

Another aspect of the present disclosure is a system for assisting a traveler, made up of a client unit and a server unit. The client unit includes an input/output (I/O) module for providing input and output services, including a speech recognition system for accepting queries from and delivering responses to the traveler, as well as a text module for receiving and transmitting SMS text messages, and a data module for handling data communication to and from the client unit. An analysis module performs analysis functions, and a data module performs data storage and processing functions. The data module includes a preferences module for storing traveler preferences, and a criteria module for storing data involving system criteria. The server unit includes a speech module, an analysis module, and a data module.

### DESCRIPTION OF THE DRAWINGS

FIG. 1 illustrates an exemplary embodiment of a system for assisting a traveler, according to the present disclosure.

FIG. 2 shows interconnections with outside service providers according to an embodiment of the present disclosure.

FIG. 3 discloses a flowchart illustrating a process for providing real-time assistance to a traveler.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

### Definitions

The term “travel” broadly includes travel by any means, including vehicles, such as automobiles, trucks, and unpowered vehicles such as bicycles, as well as travel on foot. Those skilled in the art will understand that the definitions set out above do not limit the scope of the disclosure.

### Overview

Broadly, the present disclosure relates to systems and methods for providing assistance to a traveler. The method of the present disclosure can be implemented in a system contained in, for example, an automobile or similar vehicle, or a portable device, such as a smartphone. During a particular travel segment, the system and method can perform navigational functions, answer user requests, and execute preset functions.

Navigational functions can include many of the traditional functions performed by GPS devices, but analytic capabilities provide additional functions, such as predictive route planning, as well as integration with information obtained from a variety of providers. User requests can be addressed by employing a wide scope of data processing and analysis capabilities. A local portion of a system can store information about immediate surroundings, for example, such as restaurant information within a given number of miles. Finally, the user can define preset functions. In one example, the system can monitor fuel level, and when that level falls to a preselected amount, the system can identify a nearby service station, inform the user of the need for refueling, and direct the user to the identified location.

It will easily be seen that a wide variety of activities can be executed, either on the fly or according to preset patterns, for execution according to given parameters. The discussion below will identify a number of such actions, but it will be understood that numbers of other functions will be recognizable within the ability of those having skill in the art. The discussion below should be understood as illustrative in nature, the scope of the present invention being defined solely by the claims appended hereto.

### Exemplary Embodiments

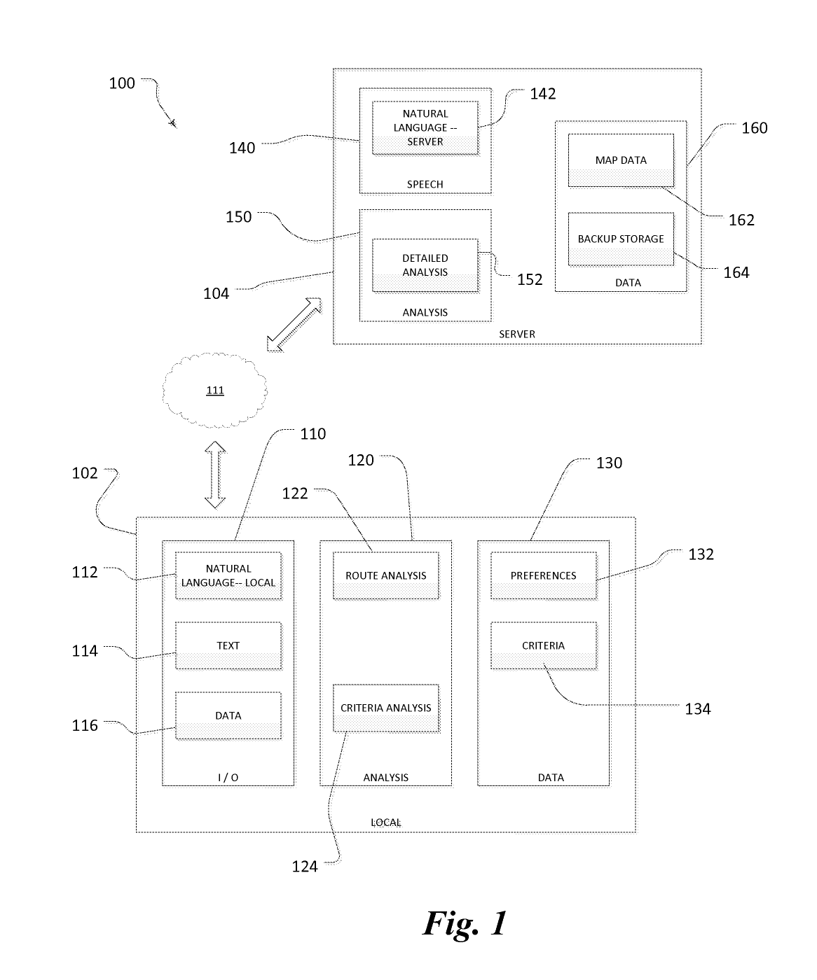

FIG. 1 is a block diagram of an embodiment of a system 100 for assisting a traveler. In general, the system includes two portions, a client unit 102 and a server module 104. The client unit 102 is adapted for mobility and portability. One embodiment of a client unit 102 could be contained in a device describable as a personal mobility unit, suitable for inclusion in devices such as a smartphone or tablet. Another embodiment could be termed a vehicular mobility unit, suitable for integration into an automobile, truck, or other vehicle. The personal mobility unit and the vehicular unit may vary in the number and scope of offered services, but for the purposes of this invention, the various mobility units may be treated similarly. Those in the art will be able to tailor specific designs to particular requirements, within the scope of the claimed invention.

Client unit 102 contains three primary components, an input/output (I/O) module 110, an analysis module 120, and a data module 130. The I/O module 110 provides input and output services, including the local portion of a speech recognition system. An analysis module 120 performs analytical functions, and this module may contain a number of sub-modules, depending upon the functions contained in the system. A data module 130 performs local data storage and data processing functions. The physical form taken by client unit 102 will very largely depend upon the particular environment for which the system is designed. For example, a vehicular system could integrate client unit 102 into the overall structure of the vehicle's on-board computer system. In that instance, some functions, such as I/O, could be shared with modules of the vehicle's system. Alternatively, a system designed for inclusion in a highly mobile device, such as a smartphone, would more likely be a standalone system with a more limited set of functions as compared to a vehicular system. Such design choices are well within the skill of those in the art.

I/O module 110 may include module such as a natural language module 112, a text module 114, and a data module 116. Natural language module 112 is the local portion of a more extensive natural language understanding system, the larger part of which is located on a remote server. The operation of such a module is explained more fully elsewhere, such as in U.S. patent application Ser. No. 13/842,735, entitled, “An Integrated Programming Framework for Speech and Text Understanding with Meaning Parsing,” filed on Mar. 15, 2013, and thus no further discussion will be provided here.

It suffices for the moment to note that natural language module 112 may often include a listing of the most frequently used vocabulary terms, and provide functionality that supports the most frequently requested tasks. Powerful remote servers handle functions that are not handled locally. The overall natural language understanding system has the option to periodically modify the local vocabulary and functional capability to reflect actual usage.

Text module 114 supports input and output of text messaging. In systems where client unit 102 is mounted in a device having cellular telephone capability, such as a smartphone, this module may consist simply of an interface to the cellular telephone text system. In a system such as a vehicular system, however, text module 114 may be required to receive an incoming text message, convert that message to a displayable format, and output the message to a screen visible to the driver. Similarly, in devices lacking any telephone capability, text module 114 may operate in conjunction with natural language module 112 to accept natural language voice input, convert that input to text format, and send that information as a text message via a cellular telephone network.

Analysis module 120 performs analytical operations supporting a number of functions provided by client unit 102. In particular, route analysis module 122 interacts with a geolocation system and map data, as discussed below, and provides detailed route analysis. Particular examples will be set out in the discussion below, but in general, route analysis module 122 takes the output of a typical GPS system and analyzes it to provide useful information to a traveler. One form of analysis, for example, can be route prediction operations, performed by analyzing the pattern of immediate past locations together with geographic information to predict likely routes of future travel, and likely locations as a function of time. This functionality will be discussed in detail below.

A criteria analysis module 124 applies analytical techniques to functional criteria to generate advice to the traveler. For example, if a functional criterion called for issuing a warning when vehicle fuel level reached ⅛ full, then the criteria analysis module 124 could both schedule and perform a set of actions required to carry out the required operation. Here for example the system might periodically monitor fuel level, employing decreased intervals as the fuel level likewise decreased, and when the criteria level was met, the criteria analysis module 124 could initiate actions to warn the driver about the requirement for refueling. These and other criteria-based actions will be discussed in detail below. In some embodiments, a context function could modify existing criteria. When the system notes a scarcity of fuel stations, it could increase the warning threshold from ⅛ tank to ¼, for example, or take into account the distance to the nearest station.

Data module 130 performs data storage and processing activities for client unit 102. For those purposes, the illustrated embodiment includes a preferences module 132 and a criteria module 134. Each of those modules handles a particular type of data, here, data involved with user preferences in preferences module 132, and data involving system criteria and criteria module 134. Each module includes functionality designed to accept, store, and process data or data classes tailored to particular functions. As additional embodiments are developed, it is anticipated that particular modules within the data module 130 will be developed to handle data defined for particular functions.

It should be clear from the discussion above that client unit 102 can be configured to perform a number of functions, based upon specific functionality contained in a given system 100. The general structure, having modules dedicated to I/O, analysis, and data handling accommodates a great number of functional variations. As additional embodiments are developed however it is fully expected that variance on these three module types, as well as completely new modules, may be developed within the scope of the present disclosure.

While development of the electronic art at the time of the present disclosure allows considerable functionality to be included in the relatively small package of client unit 102, providing effective functionality for features such as speech recognition requires that the system be structured according to a client-server model, adding a server unit 104 to client unit 102. It will further be understood that server unit 104 can be located at practically any location with respect to client unit 102, so long as a network connection of some sort is provided between the two units. The network connection can constitute a wired or wireless link, though a wireless connection will most often be employed, given the mobile nature of client unit 102. Thus, server unit 104 can be provided within any of the wide range of devices generally understood in the art as constituting a “server”. For the purposes of this application, the term “server” should be understood broadly, generally signifying a device or cluster of devices providing additional functionality to a client unit, communicating with the client unit through a communication link. It will further be understood that a single server unit 104, or cluster of units, may support a number of client units 102, and that the group of client units 102 being served can be located in a number of places. As used in this application, “server” encompasses a single unit or cluster of units, jointly providing the listed support and back end functions to the overall system.

Further, the particular makeup of server unit 104 will depend upon the particular functions included in system 100. The components of the illustrated embodiment should be understood as illustrating a typical system rather than defining universal characteristics of the present disclosure. Server unit 104 corresponds generally to the modular structure of client unit 102. Here, server unit 104 includes speech module 140, analysis module 150, and data module 160. Note that considerable interaction between modules may take place during operation, and thus it will be understood that depicting functional units is to some extent artificial.

Speech module 140 contains a natural language module 142. This module is designed to support the full functionality of a speech recognition system, complementing the forward-deployed features found in client unit 102, as described above. Speech recognition can be a complex operation, and therefore natural language module 142 could be further supported by hub language functions positioned at a central location. In general, latency and responsiveness issues will determine the relative positioning the various functions.

Analysis module 150 provides a full-featured analysis suite contained in detailed analysis module 152. The planned functionality of the system will dictate the specific nature of analysis to be performed, but the nature of server-side operations allows for the inclusion of analytical capabilities suited to the needs of particular applications, as will be clear to those in the art. In some embodiments, functions may require detailed calculations. Route prediction, provided by route analysis module 122 of client unit 102, could require considerable calculation where a number of possible routes exist, from which the most likely route must be chosen. Server-based computing power is ideally suited to such applications. Other applications will be clear to those in the art.

Data module 160 provides data storage, handling, and processing for both server unit 104 and client unit 102. Given the emphasis on geolocation operations, one can anticipate that a map data module 162, containing detailed map information, will find considerable application here. While specific data concerning the immediate surroundings of client unit 102 can be cached in the client unit data module 130, map data module 162 can be provided sufficient storage to contain geolocation and point of interest map data for a considerable area, such as the entire United States.

Backup storage module 164 will also see considerable use, as client unit 102 will typically not have the capability of backing up data to secure, non-volatile storage. Here, the entire contents of client unit 102 can periodically be dumped into backup storage module 164, providing secure storage at a location remote from client unit 102. Particular functions within client unit 102 may require frequent backups of sensitive data, and those of skill in the art will be able to implement such functions. Other specific data requirements may occur in particular embodiments, and data module 160 is sufficiently flexible to deal with such requirements.

Different embodiments of system 100 will differ in allocating functionality between client unit 102 and server unit 104. The present disclosure provides sufficient flexibility to deal with varying requirements by appropriately balancing such functionality decisions. A variety of different patterns can be employed to appropriately balance the functionality loads.

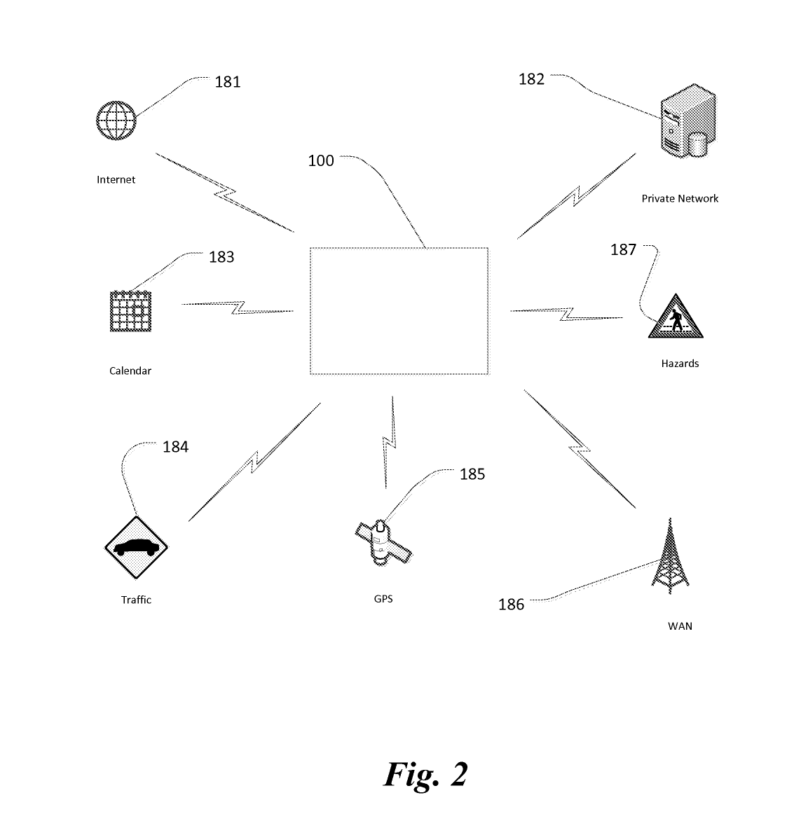

As will be clear from the discussion below, the present disclosure makes extensive use of third-party information suppliers. FIG. 2 illustrates an illustrative group of such suppliers. It will first be understood that communications with third-party information suppliers can be accomplished by any known technical means, now available or hereafter developed. Wi-Fi communication certainly can be contemplated, as can communications via a cellular telephone network. If desired, a client unit 102 (FIG. 1) can be physically plugged into a network. Alternatively, a client unit 102 could connect to a computing device, such as a laptop computer, via a USB connector. These and other communication techniques, together with techniques developed at a later date, can all establish communications with third-party providers. Those of skill in the art will understand how to accomplish such communications. Similarly, those in the art will find no difficulty interfacing with third-party suppliers, such techniques being widely available to the art.

Third-party information providers likely to interest users of the present disclosure span the range of available information providers in the market. Key devices envisioned here include portals to broad information sources, such as an Internet connection 181, connections to private networks 182, or connections to wide area networks 186. These gateways enable client unit 102 to make contact with a variety of information sources. Specific information of particular interest to travelers include a GPS or geolocation provider 185, and providers of information about hazards 187 and traffic 184. Additionally, an externally maintained calendar provider 183 could provide other useful information.

System 100, operating through the modules discussed above, can gather information from disparate sources; analyze the interaction between that information, and present information in useful form to the traveler. For example, after the employing information from GPS provider 185 to set out a desired route, system 100 can gather further information from source 187 providing information about hazards or construction projects along that route. The system can gather further insight from a traffic information provider 184. All of that information can be combined and organized, enabling the system to determine a suitable time at which to warn the traveler about a potential hazard or traffic condition. For example, a route to New York City could plan to use the Holland Tunnel. The traffic information provider 184 could note particularly heavy traffic at that location. The system could then compare traffic conditions and total travel time using the Lincoln Tunnel or the George Washington Bridge, and the system could advise the traveler accordingly. The analytical capability of system 100 would allow it to determine the optimum time to advise the traveler. In this example, if the George Washington Bridge offered the optimum crossing point into Manhattan, then the system could note that fact and advise the driver in time to reroute from the New Jersey Turnpike to the Garden State Parkway, for example. Thus, combining a wide variety of information with powerful analytic capability, the system can materially assist the traveler.

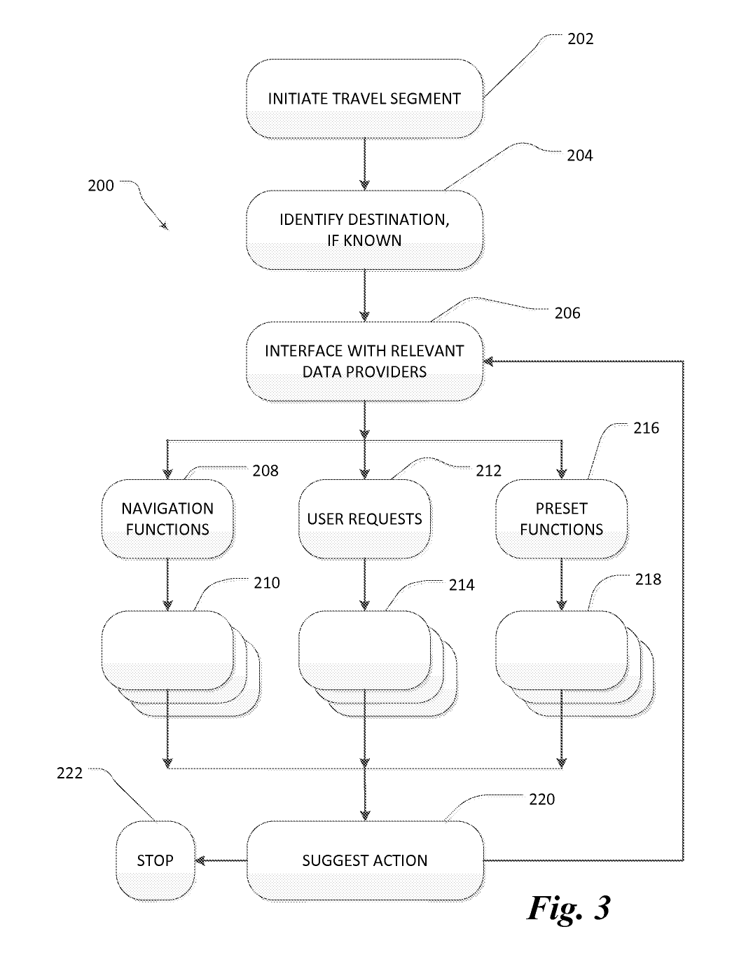

FIG. 3 sets out a flowchart for a method 200 disclosed in connection with the present disclosure, aimed at providing real-time assistance to a traveler. It should be noted initially that the examples discussed below all show system 200 operating on the exemplary system 100 set out in connection with FIGS. 1 and 2. These examples are useful, but it should be understood that any system embodying the functions of limitations of the claims set forth below can be employed to perform the system 200.

System 200 begins by initiating a travel segment, in step 202. System initiation can be manually accomplished or largely automated. In a manual initiation, the user would input preliminary information, such as user identification, mode of travel, and the like. This technique could be useful for a client unit embodied in a smartphone, for example, where some travel segments would be accomplished on foot and others would be accomplished in an automobile.

Next, in step 204, the traveler identifies the destination for the travel segment, if the destination is known. This process could be carried out through a direct interface to a GPS provider 185 (FIG. 2). Although a separate interface can accomplish the same result, it may not be worthwhile to employ such an interface. The system does have the flexibility, however, to employ a stand-alone geolocation and mapping system, using the GPS provider 185 solely as an information source. In either event, the traveler may designate a single destination, multiple destinations, or a set of waypoints. Alternatively, the traveler can skip the identify destination step, leaving the system to work with a current location and predict likely destinations.

Where the destination is not known at the outset, step 204 is skipped. In that case, the system depends on predictive analysis to provide information based on a current predicted destination. The analysis described below employs either the known destination or a current predicted destination in performing the actions described.

The system then interfaces with relevant data providers. Where a destination is set, the system could establish communications with a GPS provider 185, a traffic information provider 184, and a provider of hazard information 187 (FIG. 2), for example. Alternatively, the traveler may not be prepared to embark at that point, and the traveler may prefer to make initial contact with a calendar provider 183, or an Internet portal 181.

At this point, travel can commence. During travel, a number of threads can be executed in parallel, providing continuous functionality. Generally, functions can be divided into three broad areas—navigation functions 208, user requests 212, and preset functions 216. It will be understood that the system operates to accept and process functions employing the same general techniques that are used for other parallel processing systems, including the use of multiple threads. These techniques are well known in the art and will not be discussed further here.

Navigation functions 208 include a number of functions 210 related to navigation and geolocation. Individual navigation functions 210 can range from straightforward GPS functions, such as displaying a map of local surroundings together with one's position on that map, to more complicated actions. Because the present disclosure centers upon providing services to a traveler, navigation functions 208 form a core for many other types of functions. As will be seen below, many other functions cooperate with and draw data from navigational functions.

In some embodiments, a noted advantage of the present disclosure is the ability to perform predictive analysis. Predictive analysis allows the system to take into account the traveler's recent movements and predict a future route. This capability can be applied at a basic level by assuming that the traveler will continue moving in the same direction. Particularly in an automobile, that assumption is often not very useful. At a more sophisticated level, the system can examine the paths facing the traveler and can analyze likely routes. In one situation, for example, the traveler could be passing through relatively small, low-speed urban streets, with a high-speed route ahead, or even a choice of routes ahead. The system can prepare choices based on the most likely route, or the most likely several routes, and likely points of interest on one or more routes can be assembled for possible rapid use. For example, if the traveler has emerged onto a large city avenue from a series of side streets, with an interstate highway on-ramp ahead in the direction of travel, the system could build alternate scenarios around the situations where the traveler continues on the avenue or enters the interstate. The system could thus assemble points of interest on each route, storing data related to those points on client unit 102 for easy access.

Another set of functions deals with user requests 212. Here, the user might request information about surrounding points of interest, such as the location of the nearest Italian restaurant. A large range of user requests may be enabled for the system. For example, the traveler may wish to refuel, but she also wishes to purchase fuel at the lowest available price. The traveler can call for that function to be executed, and at that time, the system provides the relevant information. Similarly, a traveler could ask to be notified 10 minutes before reaching a particular interstate exit. Upon receiving such a request, the system would monitor both the geolocation and rate of travel, enabling it to determine when to alert the traveler.

The example set out above should indicate the broad range of predefined actions that can be provided with a system according to the present disclosure. For a system implemented on a vehicle, all vehicle functionality, as well as support system such as audio playback, can be controlled by the user. A traveler concerned about fuel economy, for example, could request that the system report current miles per gallon at preset intervals. For this purpose, “current miles per gallon” could relate to the results of any preset period, such as the current trip, the current day, etc. Together with such alerts, the traveler could ask the system to advise her about optimum speeds to maximize fuel economy. In that scenario, the system could notify the traveler that she could improve fuel economy by avoiding acceleration on long uphill climbs, for example. By combining information from a number of systems, providing information about terrain, traffic, and weather, the system can identify and advise the driver how to optimize driving parameters.

A third set of functions can be termed preset functions 216. The functions discussed above are initiated by the traveler for a particular trip, or on the fly during a trip. Preset functions 216 are actions that remain in force from one trip to another, saved in system data storage. These functions execute automatically, or they respond to a particular scenario. For example, one preset function could concern refueling warnings. In some embodiments, the system could notify the traveler that particular fuel levels had been hit, the warnings being timed at an accelerating pace. Thus, the system could warn the driver at the three-quarter tank level, the half-tank level, the three-eighths tank level, and so on. Moreover, warnings could be structured to produce a level of urgency in the traveler. Thus, at the one-eighths tank level, the system could not only warn the driver with an audio message, but lights or a visual message could reinforce the warning. For a vehicle equipped with a proximity device or a predictive accident warning system, warnings from those systems could be integrated with other systems to produce maximum attention on the warning is triggered.

Preset functions could work together with other functions as well. For example, one preset function could require the system to look for possible lunch stops if the vehicle is in movement at 11:45 AM. That system would “wake up” just before 11:45 AM, determine whether the vehicle was traveling, look for possible restaurants 15-30 minutes forward along a direction of travel, and then recommend stocks to be traveler. These functions can involve a number of information sources, as well as analysis performed both on client unit 102 and on server unit 104. Alternatively, a preset function could be keyed to specific locations. One function could recognize when the traveler seems headed toward home, and the system could alert the driver to think about stopping at the cleaners, or at the grocery store. Alternatively, the function could provide a list of restaurants suitable for a lunch meeting, located between two identified points or in a designated area. A further alternative could not only present a list but also accept a choice and dial the restaurant to obtain a reservation.

Whenever a function requires communication to the traveler, a given action is suggested at step 220. That suggestion can take the form of an audio message or a text message displayed on a screen visible to the traveler. After suggesting the action, and responding to any traveler commands, the system loops back to step 206 and reverts to the parallel processing of the three types of functions. At the end of the journey, which could be indicated in a vehicular system by the keep being turned off, the system shuts down at step 222.

The specification has described a method and system for providing real-time assistance to a traveler. Those of skill in the art will perceive a number of variations possible with the system and method set out above. These and other variations are possible within the scope of the claimed invention, which scope is defined solely by the claims set out below.

We claim:

1. A method for assisting a traveler, comprising:
initiating a travel segment;
interfacing with one or more providers of data regarding geolocation, points of interest, or traffic;
monitoring geolocation data;
predicting a route of travel, based on past geolocation data, or directions from the traveler;
identifying data of interest to the traveler, based on input initiated by the traveler; input solicited from the traveler; or predefined criteria;
providing information to the traveler relating to data of interest.

2. The method of claim 1, wherein input from the traveler is received in the form of a natural language query.

3. The method of claim 1, wherein the travel segment is conducted in an automobile or by walking.

4. The method of claim 1, wherein the predicted route has an associated level of confidence.

5. The method of claim 4, wherein providing information to the traveler occurs only when the level of confidence of the predicted route exceeds a predetermined level.

6. The method of claim 1, further comprising
receiving input from the traveler regarding a desired route of travel;
comparing the desired route of travel with the predicted route of travel; and
apprising the traveler of any differences between the desired route and the actual route.

7. The method of claim 1, further comprising:
combining information from data providers during the travel segment;
analyzing the combined information, based on preset criteria or input from the traveler;
apprising the traveler of the results of the analysis.

8. The method of claim 7, wherein the combined information includes a current time and a current location.

9. The method of claim 1, further comprising
relating data of interest to the predicted route by at least one of distance from the route and anticipated arrival time.

10. The method of claim 1, wherein data of interest are locations of a specified nature lying between identified geographic points or points of interest.

11. The method of claim 1, wherein the predefined criteria include identified danger conditions.

12. The method of claim 11, wherein the danger conditions include one or more of
low fuel level;
traffic conditions on the predicted route; or
weather conditions on the predicted route.

13. The method of claim 1, wherein providing information to the traveler is accomplished by one or more of an audio message or a visual display.

14. A system for assisting a traveler, comprising
a client unit, including
an input/output (I/O) module for providing input and output services, including
a speech recognition system for accepting queries from and delivering responses to the traveler;
a text module for receiving and transmitting sms text messages; and
a data module for handling data communication to and from the client unit;
an analysis module for performing analysis functions; and
a data module for performing data storage and processing functions, including
a preferences module for storing traveler preferences; and
a criteria module for storing data involving system criteria; and
a server unit including a speech module, an analysis module, and a data module.

15. The system of claim 14, wherein the speech recognition system accepts and outputs natural language queries and responses.

16. The system of claim 14, wherein the client unit analysis module and the server analysis module are adapted to monitor geolocation data and to predict a route of travel, based on past geolocation data or on input from the traveler.

17. The system of claim 14, wherein the client unit is configured to establish communication with third-party information providers;

18. The system of claim 17, wherein the third-party information providers include one or more of a geolocation information provider, a traffic information provider, a points of interest information provider, and an internet portal.

19. The system of claim 14, wherein the client unit is located in an automotive vehicle.

20. The system of claim 14, wherein the client unit is located in a mobile communications device.
